(19) United States
(12) Patent Application Publication
(10) Pub. No.: US 2026/0099431 A1
(43) Pub. Date: Apr. 9, 2026

(54) SOFTWARE TESTING WITH TEST CASE TIMEOUT THRESHOLD

(71) Applicant: SAP SE, Walldorf (DE)

(72) Inventors: Alexander Berndt, Speyer (DE); Sebastian Baltes, Eschborn (DE); Wolfgang Wolesak, Bad Rappenau (DE); Thomas Bach, Rauenberg (DE)

(21) Appl. No.: 18/906,824

(22) Filed: Oct. 4, 2024

(51) Int. Cl. G06F 11/36

(52) U.S. Cl. CPC G06F 11/3688

(57) ABSTRACT

Various examples are directed to systems and methods for testing software applications. A system may access first test case execution data. The first test case execution data may describe a first plurality of trial test case executions against the software application with a trial timeout threshold. Based at least in part on the first test case execution data, the system may determine a timeout probability for the first plurality of trial test case executions. The system may select a first timeout threshold based at least in part on a test case execution cost associated with the first plurality of trial test case executions and at least in part on the timeout probability for the first plurality of trial test case executions. The system may execute at least one test case against the software application using the first timeout threshold.

### BACKGROUND

Traditional modes of software development involve developing a software application and then performing error detection and debugging on the application before it is released to customers and/or other users. Error detection and debugging were time-consuming, largely manual activities.

### BRIEF DESCRIPTION OF DRAWINGS

The present disclosure is illustrated by way of example and not limitation in the following figures.

FIG. 1 is a diagram showing one example of an environment for software testing.

FIG. 2 is a diagram showing one example of a CI/CD pipeline incorporating various software testing described herein.

FIG. 3 is a flowchart showing one example of a process flow that may be executed in the environment of FIG. 1 to execute test cases using a determined timeout threshold.

FIG. 4 is a flowchart showing one example of a process flow that may be executed in the environment of FIG. 1 to execute test cases using different respective timeout thresholds for different test cases.

FIG. 5 is a block diagram showing one example of a software architecture for a computing device.

FIG. 6 is a block diagram of a machine in the example form of a computer system within which instructions may be executed for causing the machine to perform any one or more of the methodologies discussed herein.

### DETAILED DESCRIPTION

Various examples described herein are directed to software application testing and error detection with test case timeout threshold determined based on timeout flakiness.

In many software delivery environments, modifications to a software application are coded, tested, and sometimes released to users on a fast-paced timescale, sometimes quarterly, bi-weekly, or even daily. Also, large-scale software applications may be serviced by a large number of software developers, with many developers and developer teams making modifications to the software application.

In some example arrangements, a continuous integration/continuous delivery (CI/CD) pipeline, or other similar arrangement is used to support a software application. According to CI/CD pipeline, a developer entity maintains an integrated source of an application, called a mainline or mainline build. The mainline build is the most recent build of the software application that has passed all testing. At release time, the mainline build is released to and may be installed at various production environments such as, for example, at public cloud environments, private cloud environments, and/or on-premise computing systems where users can access and utilize the software application.

Between releases, a development team or teams may work to update and maintain the software application. When it is desirable for a developer user to make a change to the application, the developer user checks out a version of the mainline build from a code repository, such as a source code management (SCM) system. The mainline build is checked out into a local developer repository. The developer user makes modifications to the mainline. When the modifications are completed, the developer user initiates a commit operation. In the commit operation, the CI/CD pipeline executes a series of integration and acceptance tests to generate a new mainline build that includes the developer user's modifications. In some examples, the developer user may also initiate pre-submit testing. According to pre-submit testing, a commit operation and new build are generated and subjected to testing without the new build replacing all or part of the previous mainline build. Pre-submit testing may be used, for example, to allow developer users to test modifications to the software application between updates to the mainline build.

Applying the various integration and acceptance tests may comprise applying one or more test cases to a new build. A test case may comprise input data describing a set of input parameters provided to a build and result data describing how the build is expected to behave when provided with the set of input parameters. Executing a test case may comprise providing the set of input parameters to the build and observing how it responds. For example, a build may pass the test case if it generates an output that is equivalent to the result data. On the other hand, if the build crashes, generates incorrect output, or times-out, this may be considered a failure of the test case.

When a new build suffers a failure of at least one test case, a corrective action may be performed. The corrective action may include restoring a previous version of the build to prevent the potentially erroneous new build from reaching production. The corrective action may also include referring the new build to a developer user to identify and correct any errors in the build that may have caused the test case failure or failures.

In some examples, a test case may be flaky. A flaky test case is a test case that fails a software application (e.g., a particular build thereof) on at least one execution of the test case and also passes the software application (e.g., the same build thereof) on at least one different execution of the test case. A developer tasked with debugging or otherwise testing the software application may treat a test case failure differently if the failed test case is flaky. For example, when a software application (a build thereof) fails a test case that is not flaky, it may indicate that there is a bug or other error in the software application and a corrective action may be instituted to fix the bug or other error. When a software application fails a flaky test case, however, the failure may not be indicative of any error or bug in the software application itself. The failure of a flaky test case, then, may indicate an error or bug in the software application, an error or bug in the testing system, or other issue. In some examples, developers may ignore failures of flaky test cases and/or may treat failures of flaky test cases differently than failures of non-flaky test cases. Accordingly, in some examples, it is desirable to identify flaky test cases.

In various examples, a testing system can be configured to detect flaky test cases by rerunning failed test cases. This may include rerunning all failed test cases multiple times. In some systems, each failed test case is rerun three times, bringing the total number of executions for each failed test case to four. In other examples, failed test cases are rerun more or fewer than three times. After rerunning a test case, the testing system determines whether any of the rerun executions of the test case have passed the software application. If at least one of the rerun executions of the test case has passed the software application, then the testing system may determine that the test case is flaky. An indication that the test case is flaky may be provided to one or more developers, for example, along with results of one or more other test case executions. The developer, in some examples, may ignore test case results from flaky test cases and/or may allocate resources away from flaky test cases and towards test case failures that are not flaky. Rerunning every failed test case, however, can consume considerable computing resources including, processor resources, memory resources, network resources, and/or the like.

Timeout thresholds for test case executions may be the cause of at least some test case flakiness. A timeout threshold is a maximum amount of time that a test execution is permitted to run. If the test case execution reaches the timeout threshold without completing, the test case execution may be halted and processed as a failure of the test case. In many cases, however, the execution times for various test cases may vary, even under circumstances where the test case is running correctly and is likely to pass. If such a test case is executed with a timeout threshold that is short enough to exclude normal, but outlying execution times, the test case may behave as a flaky test case.

In various examples, timeout flakiness can be addressed by extending the timeout threshold used for test cases. Although this may reduce timeout flakiness and reduce resource efficiency losses due to re-execution of time that test cases, increasing the timeout threshold itself consumes additional computing resources. For example, every test case execution that times out under an extended timeout threshold would have also timed out under the shorter timeout threshold. Accordingly, every test case execution that times out under the extended timeout threshold consumes additional computing resources for the time between the shorter timeout threshold and the extended time not threshold. Consider an example in which the software application hangs during a test case execution. Increasing the timeout threshold may increase the amount of time that the test case execution runs futilely.

Various examples may generate a timeout threshold for one or more test cases by executing multiple instances of the test case or test cases using a range of different timeout thresholds and measuring the resulting execution time. The timeout threshold with the lowest total execution time may be used for further testing. In this example, however, executing a test case multiple different times using multiple different timeout thresholds can itself consume considerable computing resources.

Various examples address these and other challenges by utilizing cost-based techniques for selecting test case timeout thresholds. A set of trial test case executions may be performed against a software application. The set of trial test case executions may include executing a single test case against the software application and/or executing multiple test cases against the software application. The trial test case executions may be performed using a trial timeout threshold. The trial timeout threshold may be a timeout threshold that is longer, and in some examples much longer, than what would be used during usual production testing. In some examples, the trial timeout threshold is selected to permit as many test case executions as possible to complete.

Test case execution data describing the trial test case executions may be used to determine a timeout probability for the set of trial test case executions. The timeout probability is the probability that any one test case execution will timeout at a given timeout threshold. The timeout probability may be used to determine a test case execution cost. The test case execution cost may depend on various factors such as, for example, the timeout probability, the timeout threshold used, the number of re-executions performed for a timed-out test case execution, and/or the like. A timeout threshold may be selected to optimize the test case execution cost, for example, by finding the timeout threshold that brings about the lowest test case execution cost. This timeout threshold may be used for subsequent test case executions.

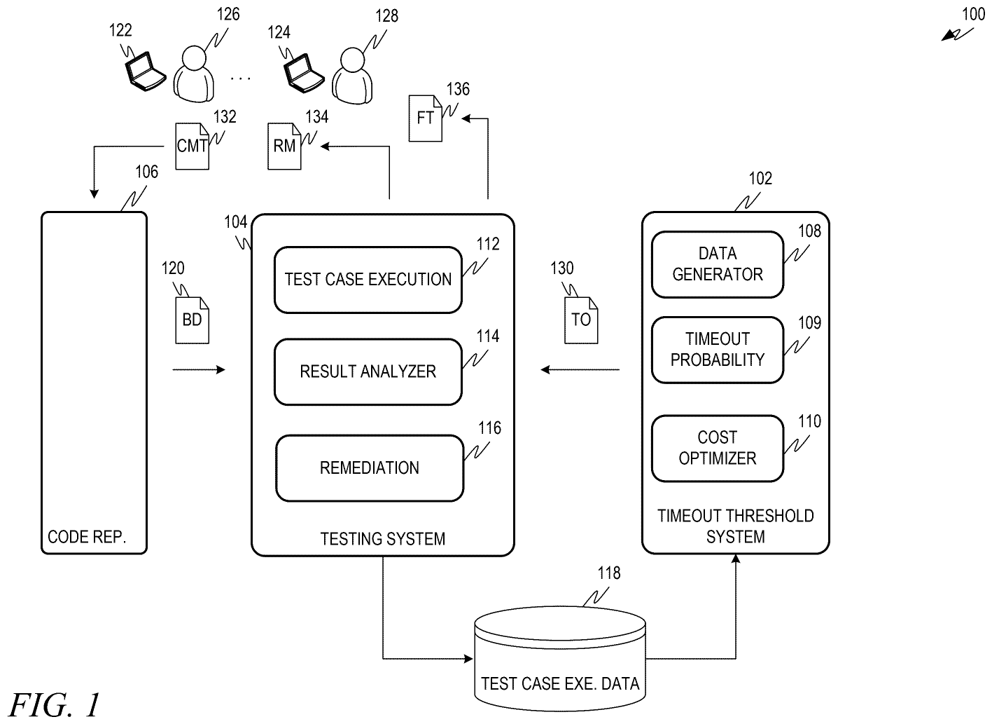

FIG. 1 is a diagram showing one example of an environment 100 for software testing. The environment 100 comprises a timeout threshold system 102, a testing system 104, and a code repository 106, which may be all or part of an SCM system. The timeout threshold system 102, testing system 104, and code repository 106 may include one or more computing devices that may be located at a single geographic location and/or distributed across different geographic locations. In some examples, the timeout threshold system 102 and testing system 104 may be implemented at a common computing system, cloud installation, and/or the like.

One or more developer users 126, 128 may generate commit operations, such as commit operation 132. Developer users 126, 128 may utilize user computing devices 122, 124. User computing devices 122, 124 may be or include any suitable computing device such as, for example, desktop computers, laptop computers, tablet computers, mobile computing devices, and/or the like. One or more of the developer users 126, 128 may check out a mainline of a software application from the code repository 106. The commit operation 132 may include changes to the previous mainline build. The commit operation 132 may result in a new build 120. In some examples, the new build 120 is subjected to pre-submit testing before it is submitted for incorporation into and/or replacement of the previous mainline. As described herein, this pre-submit testing can be initiated by the developer users 126, 128 as they develop the software application. In some examples, developer users 126, 128 will not submit a new build 120 for incorporation into and/or replacement of the previous mainline until it has passed pre-submit testing. Also, in some examples, submission of a new build 120 may happen periodically, such as for example, once a day, twice a day, every other day, and/or the like. New builds generated between periodic submissions may be subjected to pre-submit testing.

The testing system 104 may perform integration and acceptance tests on the changes implemented by the new build 120. The testing system 104 may comprise a test case execution system 112 for executing test cases, a result analyzer system 114 for analyzing results of test case executions, in a remediation system 116 for mediating failed test case executions. The various systems 112, 114, 116 may be implemented using various hardware and/or software subcomponents of the testing system 104. In some examples, one or more of the systems 112, 114, 116 is implemented on a discrete computing device or set of computing devices.

The testing system 104 is configured to test the new build 120 by executing one or more test cases. A test case may comprise input data describing a set of input parameters provided to a software application, such as the build 120, and result data describing how the software application is expected to behave when provided with the set of input parameters. The test case execution system 112 may execute a test case by executing the new build 120, applying the test parameters of the test case to the new build 120, and observing the response of the new build 120. The test case execution system 112 may execute test cases with timeout thresholds that may be determined, for example, as described herein. For example, the test case execution system 112 may execute test cases with one or more timeout thresholds 130 generated by the timeout threshold system 102, as described herein.

Consider an example in which the new build 120 is or includes a database management application. Test case data may comprise a set of one or more queries to be executed by the database management application and result data describing how the database management application should behave in response to the queries. The new build 120 may pass the test case if it generates the expected result data in response to the provided queries before expiration of the timeout threshold. Conversely, the new build 120 may fail the test case if it fails to produce result data prior to the timeout threshold or generates result data that is different than the expected result data.

During pre-submit testing, results of the test cases may be provided to one or more of the developer users 126, 128. In this way, the developer users 126, 128 may make modifications to be incorporated into later builds. During submission testing, results of the test cases may determine whether the new build 120 is deployed to supplement and/or replace the existing mainline build. For example, if the new build 120 passes all test cases, then it may be deployed as a new mainline build. If the new build 120 fails one or more test cases, it may not be deployed to supplement and/or replace the existing mainline build of the software application.

The result analyzer system 114 is configured to review results of test case executions and determine whether the test case execution passed or failed the new build 120. The new build 120 may pass the test case if it responds to the input data in the way described by the result data. If a build fails to respond to the input data in the way described by the result data, the build may fail the test case. For example, if the new build 120 generates an output that is not consistent with the result data, the new build 120 may fail the test case execution. The new build 120 may also fail the test case execution, for example, if it fails to complete its execution prior to the timeout threshold for the test case execution. This may occur, for example, if the new build 120 has crashed or hung or, for example, if the new build 120 has not crashed but has, nonetheless, failed to complete its processing prior to the timeout threshold.

When the new build 120 fails one or more test cases, the result analyzer system 114 may generate data describing the failed test case. The data may include, for example, stack trace data and error message data. Stack trace data describes function calls made by the software application during execution of a failed test case. For example, the stack trace data may include function names, line numbers, file names, source code lines, and or like data for each function called during execution of the test case. Error message data includes error message is generated by the software application during execution of the test case.

If the result analyzer system 114 determines that a test case execution has failed, the result analyzer system 114 may prompt the test case execution system 112 to re-execute the failed test case a number of times to determine whether the failed test case execution indicated a flaw in the new build 120 or a flaky test case. In some examples, the number of re-executions is three. If the software application fails all of the re-executions, then the result analyzer system 114 may prompt the remediation system 116 to initiate a corrective action.

If the software application passes at least one of the additional executions, then the test case execution may be considered passed, and the test case may be considered flaky. In response, the result analyzer system 114 may provide a flaky test case message 136 to one or more developer users 126, 128. The flaky test case message 136 may include information about the flaky test case such as, for example, a pending stack trace data and/or error message data for the test case to the stack trace data and/or error message data for the known-flaky test cases described by the flaky test case data. In some examples, the flaky test message 136 is provided to the developer user 126, 128 who made the commit operation 132 to create the new build 120 and/or to a different developer user 126, 128. In some examples, a test case that is determined to be flaky may not be used for subsequent new builds, for example, until the flightiness of the test case has been addressed.

The remediation system 116 may execute one or more corrective actions when a new build 120 fails a test case execution and it is determined that the test case is not flaky, for example, if the new build 120 also fails all re-executions of the test case. In some examples, the remediation system 116 sends a report message 134 to one or more developer users 126, 128. The report message 134 may comprise an indication of the commit operation 132 and/or the new build 120. In some examples, the report message 134 includes or describes the stack trace data of one or more crash failures of the new build 120 during the application of test cases. For example, the report message 134 may provide an indication of a component or other portion of the software application that is associated with each function call in the stack trace data or stack trace data.

The report message 134 may also provide an indication of whether any crash failures of the new build 120 are duplicates of one another and/or duplicates of known errors in the software application. In some examples, the remediation system 116 routes the report message 134 to the developer user 126, 128 that submitted the error-inducing commit operation or to a different developer user 126, 128.

Another example corrective action that may be taken by the remediation system 116 includes reverting the software application to a good build. A good build may be a build that was generated by a commit operation prior to the commit operation 132. In some examples, the good build is the build generated by the commit operation immediately before the error-inducing commit operation 132.

In various examples, the timeout threshold system 102 may generate one or more timeout thresholds 130, which may be provided to the testing system 104. The testing system 104 (e.g. the test case execution system 112 thereof) may execute test cases using the provided timeout threshold or thresholds 130.

The timeout thresholds system 102 may comprise a data generator system 108, a timeout probability system 109, and a cost optimizer system 110. The various systems 108, 109, 110 may be implemented using various hardware and/or software subcomponents of the timeout threshold system 102. In some examples, one or more of the systems 108, 109, 110 is implemented on a discrete computing device or set of computing devices.

The data generator system 108 may generate test case execution data using a trial timeout threshold. For example, the data generator system 108 may prompt the testing system 104 (e.g., the test case execution system 112 thereof) to execute a plurality of trial test case executions. The data generator system 108 may provide an indication of one or more test cases. In some examples, the data generator system may also provide an indication of the trial timeout threshold. In some examples, the data generator system 108 also provides an indication of a software application that is to be subject to the trial test case executions. This may be a build of a software application managed by the code repository 106 and, in some example, may be the new build 120.

In some examples, the data generator system 108 prompts trial test case executions using multiple test cases. For example, if a set of X test cases is used to test new builds, such as the new build 120, the data generator system 108 may instruct the testing system 104 (e.g., the test case execution system 112 thereof) to perform the trial test case executions using the same set of X test cases. In other examples, the data generator system 108 prompts trial test case executions using a single test case. Test case execution data generated from trial test case executions using a single test case may be used, for example, to generate a timeout threshold specific to that test case, for example, as described herein.

The trial timeout threshold may be larger, and in some examples, much larger than production timeout thresholds used by the test case execution system 112 for other pre- and post-submit testing of the new build 120. This may be to permit trial test case executions to conclude even if the trial test case executions would not otherwise conclude within a production timeout threshold. Consider an example in which production timeout thresholds are between about 90 seconds and about five minutes. In such an example, the trial timeout threshold may be between about 25 minutes and 45 minutes. In some examples, the trial timeout threshold may be about 30 minutes.

The testing system 104 (e.g. the test case execution system 112 thereof) may execute the trial test case executions. It may generate test case execution data describing the trial test case executions. The test case execution data may be provided to the timeout thresholds system 102. In some examples, the testing system 102 (e.g. the test case execution system 112) writes the test case execution data to a test case execution data store 118, where it may be accessed by the timeout thresholds system 102.

The timeout probability system 109 uses the test case execution data to a timeout probability for the test case or test cases used for the trial test case executions. The timeout probability may be determined depending on the timeout thresholds used. For example, the timeout probability for the considered test case or test cases may be expressed as described by Expression [1] below:

$$1 - P ( T < {t}_{max} ) \qquad [ 1 ]$$

In Expression [1], tₘₐₓ is the timeout threshold and T is a random variable describing the execution time of a test case. P is the probability that the execution time of the test case is less than the timeout threshold.

In some examples, the timeout probability system 109 approximates the timeout probability for the test case or test cases utilizing probabilistic concentration inequalities. For example, the timeout probability system 109 may determine a characteristic distribution of the execution time of the trial test case executions. The timeout probability system 109 may determine a mean and a variance of the execution times for the trial test case executions. The determined distribution may be used to solve a probabilistic concentration inequality, such as the Cantelli inequality describe by Equation [2] below:

$$P ( X - \overline{X} \geq λ {Q}_{n} ) \leq \frac{1}{n + 1} \cdot ⌊ \frac{n + 1}{{k}^{2} + 1} ⌋ \qquad [ 2 ]$$

In Equation [2], X̅ is the mean execution time of the trial test case executions and n is the size of the trial. The value Qₙ is based on the variance of the trial test case execution times and may be given by Equation [3] below:

$${Q}_{n}^{2} = [ \frac{n + 1}{n} ] {S}_{n}^{2} \qquad [ 3 ]$$

In Equation [3],

$${S}_{n}^{2}$$

is the variance of the trial test case execution times. Also, referring back to Equation [2], k² may be given by Equation [4] below:

$${k}^{2} = \frac{n \cdot {λ}^{2}}{n - 1 + {λ}^{2}} \qquad [ 4 ]$$

In Equation [9], the upper bound for A may be given by (X−\bar{X})/Q_n. The timeout probability system 109 may be programmed to solve the inequality, similar to the Cantelli inequality described by Equations [2]-[4], to determine for the first plurality of trial test case executions.

The cost optimizer system 110 may utilize the timeout probability for the trial test case executions determined by the timeout probability system 109 to determine a timeout threshold for the test case or text cases used for the trial test case executions. For example, the timeout probability system 109 may utilize an expression of cost describing cost of a test case execution. An example of such an expression is given by Equation [5] below:

$$C ( {t}_{max} ) = {\overline{T}}_{tmax} + m \cdot ( ( 1 - P ( T < {t}_{max} ) ) \cdot {\overline{T}}_{tmax} \qquad [ 5 ]$$

In Equation [5], C(tₘₐₓ) is the cost of executing a test case using a given timeout threshold, indicated by tₘₐₓ. T̅ₜₘₐₓ is the mean execution time of the test case given the timeout threshold tₘₐₓ. The quantity m is the number of times that a timed-out test case execution is re-executed. Accordingly, the cost described by Equation [5] is the timeout threshold for one mean test case execution plus m times the likelihood of a timeout multiplied by the mean test execution time. The cost optimizer system 110 may be configured to find a timeout threshold by minimizing the cost, for example, as described by Equation [6] below:

$${t}_{max}^{*} = {}_{{t}_{max}}^{argmin} C ( {t}_{max} ) \qquad [ 6 ]$$

In some examples, the cost optimizer system 110 may further consider the cost of breakage. Breakage is when the test case fails all re-executions. If breakage occurs, each test case execution will have an execution time equal to the timeout threshold. An expression of test case because considering breakage is given by Equation [7] below:

$$C ( {t}_{max} ) = {\overline{T}}_{tmax} + m \cdot ( ( 1 - P ( T < {t}_{max} ) ) \cdot {\overline{T}}_{tmax} + {P}_{btmax} ( m + 1 ) \qquad [ 7 ]$$

In Equation [7], P_{btmax} is the probability of breakage. In some examples, rather than estimating the probability of breakage, the cost optimizer system 110 may restrict the upper bound of the timeout threshold tₘₐₓ, for example, as described by Equation [8] below:

$${t}_{max} ∈ [ \overline{T} , 2 \cdot max ( T ) ] \qquad [ 8 ]$$

According to Equation [8], a new timeout threshold may not be larger than twice the value of the highest previous execution time.

In some examples, the cost optimizer system 110 may also consider in the expression of a test case cost, a cost associated with a developer user 126, 128 analyzing a test case if it fails both the initial test case execution and the number of re-executions. For example, a value indicating the cost of developer user time for manually reviewing the results of timed-out cases. The value, in some examples, may be multiplied by the probability of breakage.

In some examples, the timeout threshold system 102 may generate test case-specific timeout thresholds. For example, the data generator system 108 may prompt the testing system 104 (e.g. the test case execution system 112 thereof) to generate test case execution data describing trial test case executions of a single test case. The timeout probability system 109 and cost optimizer system 110 may operate on the resulting test case execution data to generate a timeout threshold for the considered test case. The process may be repeated for additional test cases. When the testing system 104 generates regular pre-submit and post-submit testing of the new build, such as the new build 120, it may use different timeout thresholds for different test cases, for example, as determined by the timeout threshold system 102.

In other examples, the timeout threshold system 102 may generate a single timeout threshold that is to be used for multiple test cases. For example, the data generator system 108 may prompt the testing system 104 (e.g. the test case execution system 112 thereof) to generate test case execution data describing trial test case executions of a set of multiple test cases such as, for example, all the test cases that are applied to a new build in pre-submit or post-submit testing. The timeout probability system 109 and cost optimizer system 110 may operate on the resulting test case execution data to generate a single timeout threshold that may be used by the testing system 104 for all of the set of test cases.

In some examples, changes to the software application may change the way that different test cases operate. For example, a test case that is flaky may become less flaky as different new builds modify the overall software application. Also, for example, some test cases may be modified by developer users 126, 128 for various reasons. Accordingly, the timeout threshold system 102 may be configured to periodically redetermine time out thresholds for different respective test cases and/or for a set of multiple test cases.

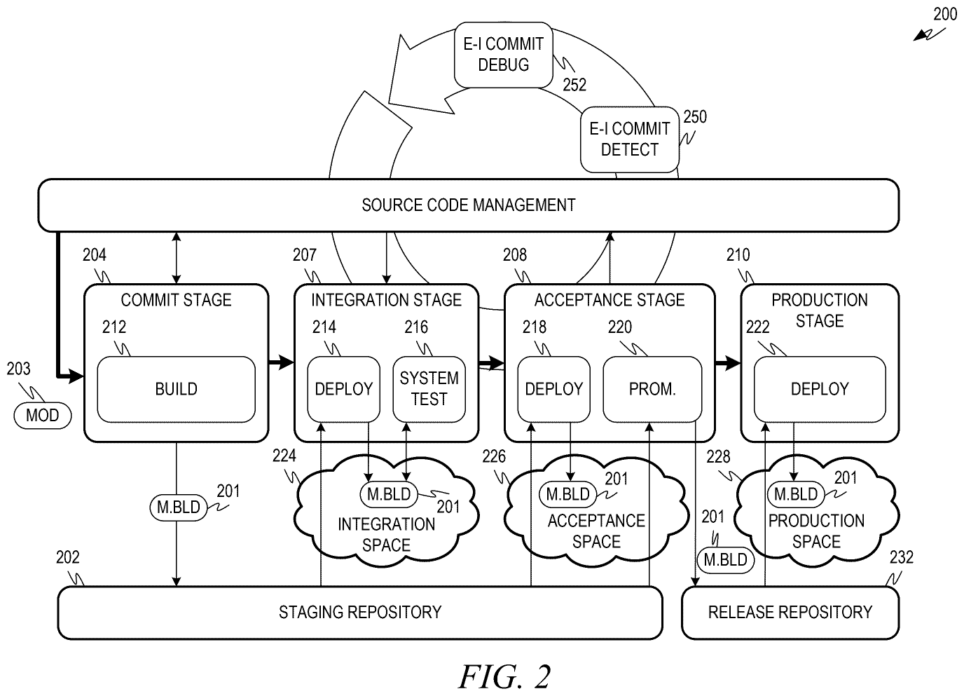

FIG. 2 is a diagram showing one example of a CI/CD pipeline 200 incorporating various software testing described herein. The CI/CD pipeline 200 is initiated when a developer user, such as one of developer users 126, 128, submits a build modification 203 to the commit stage 204, initiating a commit operation. The build modification 203 may include a modified version of the mainline build previously downloaded by the developer user 126, 128.

The commit stage 204 executes a commit operation 212 to create and/or refine the modified software application build 201. For example, the mainline may have changed since the time that the developer user 126, 128 downloaded the mainline version used to create the build modification 203. The modified software application build 201 generated by commit operation 212 includes the changes implemented by the modification 203 as well as any intervening changes to the mainline. The commit operation 212 and/or commit stage 204 stores the modified software application build 201 to a staging repository 202 where it can be accessed by various other stages of the CI/CD pipeline 200.

An integration stage 207 receives the modified software application build 201 for further testing. A deploy function 214 of the integration stage 207 deploys the modified software application build 201 to an integration space 224. The integration space 224 is a test environment to which the modified software application build 201 can be deployed for testing. While the modified software application build 201 is deployed at the integration space 224, a system test function 216 performs one or more integration tests on the modified software application build 201. In some examples, the testing system 104 of FIG. 1 may be utilized to perform all or part of the system test function 216. If the modified software application build 201 fails one or more of the test cases, it may be returned to the developer user 126, 128 for correction. If the modified software application build 201 passes testing, the integration stage 207 provides an indication indicating the passed testing to an acceptance stage 208.

The acceptance stage 208 uses a deploy function 218 to deploy the modified software application build 201 to an acceptance space 226. The acceptance space 226 is a test environment to which the modified software application build 201 can be deployed for testing. While the modified software application build 201 is deployed at the acceptance space 226, a promotion function 220 applies one or more promotion tests to determine whether the modified software application build 201 is suitable for deployment to a production environment. Example acceptance tests that may be applied by the promotion function 220 include Newman tests, UiVeri5 tests, Gauge BDD tests, various security tests, etc. If the modified software application build 201 fails the testing, it may be returned to the developer user 126, 128 for correction. If the modified software application build 201 passes the testing, the promotion function 220 may write the modified software application build 201 to a release repository 232, from which it may be deployed to production environments.

The example of FIG. 2 shows a single production stage 210. The production stage 210 includes a deploy function 222 that reads the modified software application build 201 from the release repository 232 and deploys the modified software application build 201 to a production space 228. The production space 228 may be any suitable production space or environment as described herein.

The various examples for software testing described herein may be implemented during the acceptance stage 208 and/or the integration stage 207. An error-inducing detection operation 250 may be executed by the testing system 102 utilizing fault localization, for example. An error-inducing commit debug or correction operation 252 may be executed by the testing system 102 (e.g., the corrective action system 108) as described herein.

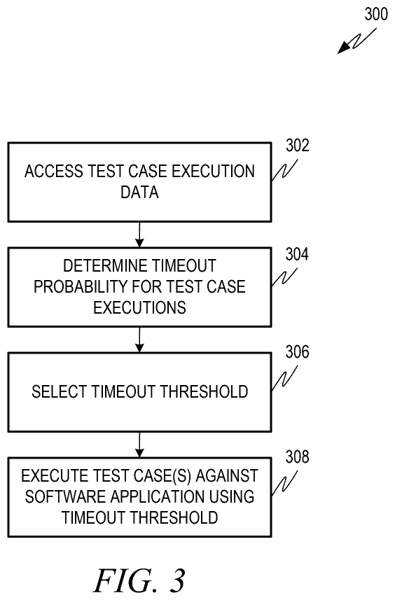

FIG. 3 is a flowchart showing one example of a process flow 300 that may be executed in the environment 100 of FIG. 1 to execute test cases using a determined timeout threshold. At operation 302, the timeout threshold system 102 may access test case execution data describing a plurality of trial test case executions against a software application, such as the new build 120 of FIG. 1. In some examples, the test case execution data may be received directly from the testing system 104 and/or received from a test case execution data store 118.

At operation 304, the timeout threshold system 102 may determine a timeout probability for the trial test case executions described by the test case execution data. At operation 306, the timeout threshold system 102 may select a timeout threshold based on the plurality of trial test case executions. The timeout threshold may be determined, for example, by minimizing the cost of executing the test cases.

At operation 308, the testing system 102 may execute one or more test cases against the software application using the determined timeout threshold. For example, operation 308 may be performed as a part of pre-submit or post-submit testing, as described herein. In some examples, if the plurality of trial test cases were run using a single test case, the test case executions at operation 308 may be run using the same test case. Also, in some examples, if the plurality of trial test cases were run using multiple different test cases, the test case executions at operation 308 may be executed using test cases selected from the multiple different test cases or different test cases.

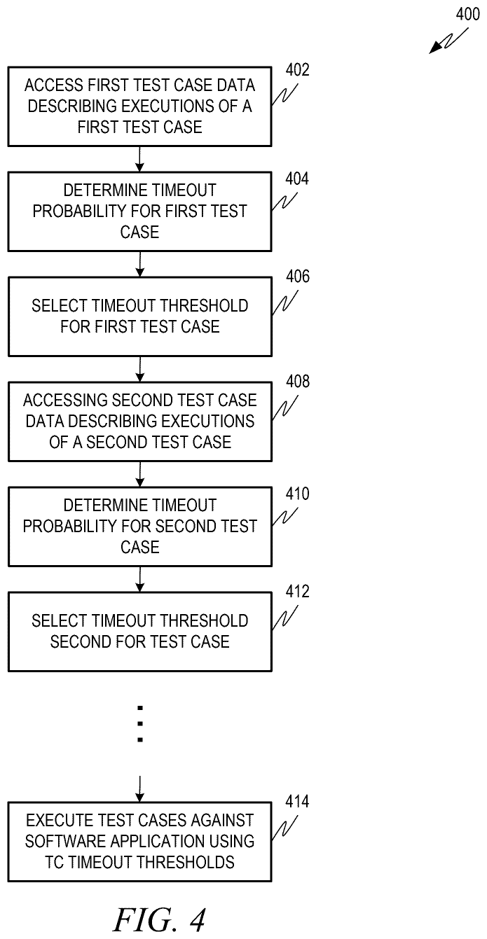

FIG. 4 is a flowchart showing one example of a process flow 400 that may be executed in the environment 100 of FIG. 1 to execute test cases using different respective timeout thresholds for different test cases. At operation 402, the timeout threshold system 102 may access first test case execution data describing a plurality of trial test case executions against a software application using a first test case. At operation 404, the timeout threshold system 102 may determine a timeout probability for the first test case. At operation 406, the timeout threshold system 102 may select a timeout threshold for the first test case based on the plurality of trial test case executions described by the first test case execution data. The timeout threshold may be determined, for example, by minimizing the cost of executing the first test case.

At operation 408, the timeout threshold system 102 may access second test case execution data describing a plurality of trial test case executions against a software application using a second test case. At operation 410, the timeout threshold system 102 may determine a timeout probability for the second test case. At operation 412, the timeout threshold system 102 may select a timeout threshold for the second test case based on the plurality of trial test case executions described by the second test case execution data. The timeout threshold may be determined, for example, by minimizing the cost of executing the test cases.

The timeout threshold system 102 may continue determining test case-specific timeout thresholds in this manner until all desired test cases are considered. At operation 414, the testing system 104 may execute the considered test cases against a software application using the respective threshold timeout for the respective test cases.

In view of the disclosure above, various examples are set forth below. It should be noted that one or more features of an example, taken in isolation or combination, should be considered within the disclosure of this application.

### EXAMPLES

Example 1 is a system for testing a software application, comprising: at least one processor programmed to perform operations comprising: accessing first test case execution data, the first test case execution data describing a first plurality of trial test case executions against the software application with a trial timeout threshold; based at least in part on the first test case execution data, determining a timeout probability for the first plurality of trial test case executions; selecting a first timeout threshold based at least in part on a test case execution cost associated with the first plurality of trial test case executions and at least in part on the timeout probability for the first plurality of trial test case executions; and executing at least one test case against the software application using the first timeout threshold.

In Example 2, the subject matter of Example 1 optionally includes the first plurality of trial test case executions comprising executions of a first test case against the software application and executions of a second test case against the software application, the executing of the at least one test case against the software application comprising: executing the first test case against the software application using the first timeout threshold; and executing the second test case against the software application using the first timeout threshold.

In Example 3, the subject matter of any one or more of Examples 1-2 optionally includes the executing of the at least one test case against the software application using the first timeout threshold comprising executing a first test case against the software application using the first timeout threshold, the operations further comprising: accessing second test case execution data, the second test case execution data describing a second plurality of trial test case executions of a second test case against the software application with the trial timeout threshold; based at least in part on the second test case execution data, determining a timeout probability for the second test case; selecting a second timeout threshold based at least in part on a test case execution cost associated with the second test case and at least in part on the timeout probability for the second test case; and executing the second test case against the software application using the second timeout threshold.

In Example 4, the subject matter of any one or more of Examples 1-3 optionally includes the selecting of the first timeout threshold comprising selecting the first timeout threshold to minimize the test case execution cost associated with the first plurality of trial test case executions.

In Example 5, the subject matter of Example 4 optionally includes the operations further comprising: determining an expression of the test case execution cost, the expression of the test case execution cost being based at least in part on a mean execution time of the first plurality of trial test case executions, a re-execution time for timed-out test case executions, and the timeout probability for the first plurality of trial test case executions; and selecting the first timeout threshold to minimize the expression of the test case execution cost with the timeout probability.

In Example 6, the subject matter of any one or more of Examples 1-5 optionally includes the selecting of the first timeout threshold also being based at least in part on a re-execution time for timed-out test case executions.

In Example 7, the subject matter of Example 6 optionally includes the re-execution time for timed-out test case executions being based at least in part on a number of re-executions performed for timed-out test case executions.

In Example 8, the subject matter of any one or more of Examples 1-7 optionally includes the selecting of the first timeout threshold also being based at least in part on a manual review time for manually reviewing results of timed-out test cases.

In Example 9, the subject matter of any one or more of Examples 1-8 optionally includes the first timeout threshold being less than the trial timeout threshold.

Example 10 is a method of testing a software application, comprising: accessing first test case execution data, the first test case execution data describing a first plurality of trial test case executions against the software application with a trial timeout threshold; based at least in part on the first test case execution data, determining a timeout probability for the first plurality of trial test case executions; selecting a first timeout threshold based at least in part on a test case execution cost associated with the first plurality of trial test case executions and at least in part on the timeout probability for the first plurality of trial test case executions; and executing at least one test case against the software application using the first timeout threshold.

In Example 11, the subject matter of Example 10 optionally includes the first plurality of trial test case executions comprising executions of a first test case against the software application and executions of a second test case against the software application, the executing of the at least one test case against the software application comprising: executing the first test case against the software application using the first timeout threshold; and executing the second test case against the software application using the first timeout threshold.

In Example 12, the subject matter of any one or more of Examples 10-11 optionally includes the executing of the at least one test case against the software application using the first timeout threshold comprising executing a first test case against the software application using the first timeout threshold, the method further comprising: accessing second test case execution data, the second test case execution data describing a second plurality of trial test case executions of a second test case against the software application with the trial timeout threshold; based at least in part on the second test case execution data, determining a timeout probability for the second test case; selecting a second timeout threshold based at least in part on a test case execution cost associated with the second test case and at least in part on the timeout probability for the second test case; and executing the second test case against the software application using the second timeout threshold.

In Example 13, the subject matter of any one or more of Examples 10-12 optionally includes the selecting of the first timeout threshold comprising selecting the first timeout threshold to minimize the test case execution cost associated with the first plurality of trial test case executions.

In Example 14, the subject matter of Example 13 optionally includes determining an expression of the test case execution cost, the expression of the test case execution cost being based at least in part on a mean execution time of the first plurality of trial test case executions, a re-execution time for timed-out test case executions, and the timeout probability for the first plurality of trial test case executions; and selecting the first timeout threshold to minimize the expression of the test case execution cost with the timeout probability.

In Example 15, the subject matter of any one or more of Examples 10-14 optionally includes the selecting of the first timeout threshold also being based at least in part on a re-execution time for timed-out test case executions.

In Example 16, the subject matter of Example 15 optionally includes the re-execution time for timed-out test case executions being based at least in part on a number of re-executions performed for timed-out test case executions.

In Example 17, the subject matter of any one or more of Examples 10-16 optionally includes the selecting of the first timeout threshold also being based at least in part on a manual review time for manually reviewing results of timed-out test cases.

In Example 18, the subject matter of any one or more of Examples 10-17 optionally includes the first timeout threshold being less than the trial timeout threshold.

Example 19 is a non-transitory machine-readable medium comprising instructions thereon that, when executed by at least one processor, because the at least one processor to perform operations comprising: accessing first test case execution data, the first test case execution data describing a first plurality of trial test case executions against a software application with a trial timeout threshold; based at least in part on the first test case execution data, determining a timeout probability for the first plurality of trial test case executions; selecting a first timeout threshold based at least in part on a test case execution cost associated with the first plurality of trial test case executions and at least in part on the timeout probability for the first plurality of trial test case executions; and executing at least one test case against the software application using the first timeout threshold.

In Example 20, the subject matter of Example 19 optionally includes the first plurality of trial test case executions comprising executions of a first test case against the software application and executions of a second test case against the software application, the executing of the at least one test case against the software application comprising: executing the first test case against the software application using the first timeout threshold; and executing the second test case against the software application using the first timeout threshold.

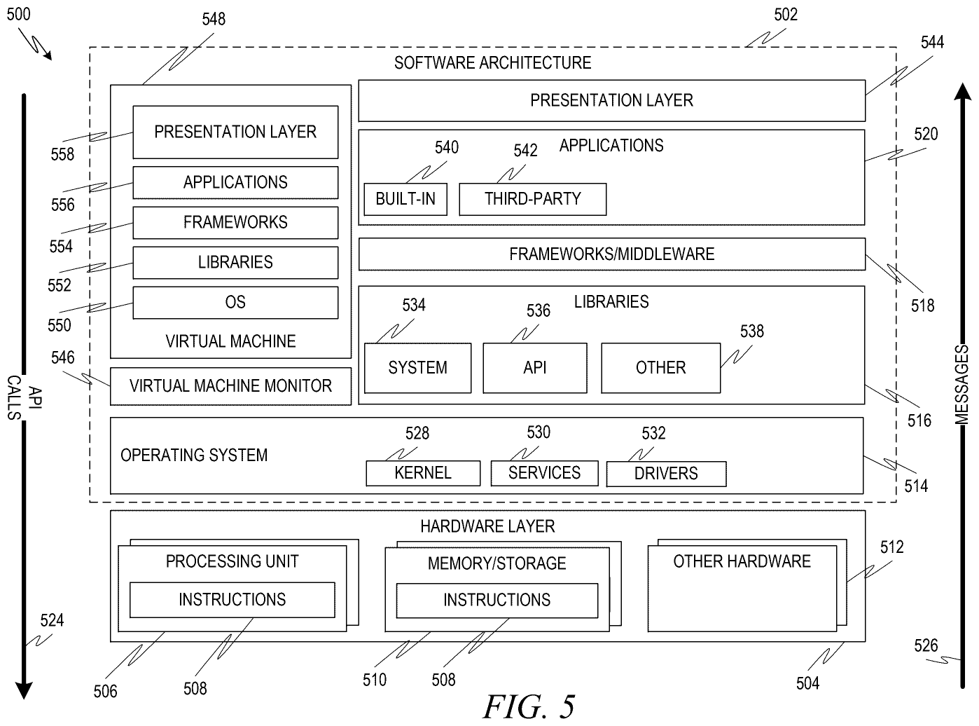

FIG. 5 is a block diagram 500 showing one example of a software architecture 502 for a computing device. The software architecture 502 may be used in conjunction with various hardware architectures, for example, as described herein. FIG. 5 is merely a non-limiting example of a software architecture and many other architectures may be implemented to facilitate the functionality described herein. The software architecture 502 and various other components described in FIG. 5 may be used to implement various other systems described herein. For example, the software architecture 502 shows one example way for implementing a testing system 104 or other computing devices described herein.

In FIG. 5, a representative hardware layer 504 is illustrated and can represent, for example, any of the above referenced computing devices. In some examples, the hardware layer 504 may be implemented according to the architecture of the computer system of FIG. 5.

The representative hardware layer 504 comprises one or more processing units 506 having associated executable instructions 508. Executable instructions 508 represent the executable instructions of the software architecture 502, including implementation of the methods, modules, systems, and components, and so forth described herein and may also include memory and/or storage modules 510, which also have executable instructions 508. Hardware layer 504 may also comprise other hardware as indicated by other hardware 512 which represents any other hardware of the hardware layer 504, such as the other hardware illustrated as part of the software architecture 502.

In the example architecture of FIG. 5, the software architecture 502 may be conceptualized as a stack of layers where each layer provides particular functionality. For example, the software architecture 502 may include layers such as an operating system 514, libraries 516, middleware layer 518 (sometimes referred to as frameworks), applications 520, and presentation layer 544. Operationally, the applications 520 and/or other components within the layers may invoke API calls 524 through the software stack and access a response, returned values, and so forth illustrated as messages 526 in response to the API calls 524. The layers illustrated are representative in nature and not all software architectures have all layers. For example, some mobile or special purpose operating systems may not provide the middleware layer 518, while others may provide such a layer. Other software architectures may include additional or different layers.

The operating system 514 may manage hardware resources and provide common services. The operating system 514 may include, for example, a kernel 528, services 530, and drivers 532. The kernel 528 may act as an abstraction layer between the hardware and the other software layers. For example, the kernel 528 may be responsible for memory management, processor management (e.g., scheduling), component management, networking, security settings, and so on. The services 530 may provide other common services for the other software layers. In some examples, the services 530 include an interrupt service. The interrupt service may detect the receipt of an interrupt and, in response, cause the software architecture 502 to pause its current processing and execute an interrupt service routine (ISR) when an interrupt is accessed.

The drivers 532 may be responsible for controlling or interfacing with the underlying hardware. For instance, the drivers 532 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 516 may provide a common infrastructure that may be utilized by the applications 520 and/or other components and/or layers. The libraries 516 typically provide functionality that allows other software modules to perform tasks in an easier fashion than to interface directly with the underlying operating system 514 functionality (e.g., kernel 528, services 530 and/or drivers 532). The libraries 516 may include system 534 libraries (e.g., C standard library) that may provide functions such as memory allocation functions, string manipulation functions, mathematic functions, and/or the like. In addition, the libraries 516 may include API libraries 536 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and/or the like. The libraries 516 may also include a wide variety of other libraries 538 to provide many other APIs to the applications 520 and other software components/modules.

The middleware layer 518 (also sometimes referred to as frameworks) may provide a higher-level common infrastructure that may be utilized by the applications 520 and/or other software components/modules. For example, the middleware layer 518 may provide various graphic user interface (GUI) functions, high-level resource management, high-level location services, and so forth. The middleware layer 518 may provide a broad spectrum of other APIs that may be utilized by the applications 520 and/or other software components/modules, some of which may be specific to a particular operating system or platform.

The applications 520 include built-in applications 540 and/or third-party applications 542. Examples of representative built-in applications 540 may include, but are not limited to, a contacts application, a browser application, a book reader application, a location application, a media application, a messaging application, and/or a game application. Third-party applications 542 may include any of the built-in applications 540 as well as a broad assortment of other applications. In a specific example, the third-party application 542 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 542 may invoke the API calls 524 provided by the mobile operating system, such as operating system 514, to facilitate functionality described herein.

The applications 520 may utilize built-in operating system functions (e.g., kernel 528, services 530 and/or drivers 532), libraries (e.g., system 534, API libraries 536, and other libraries 538), and middleware layer 518 to create user interfaces to interact with users of the system. Alternatively, or additionally, in some systems interactions with a user may occur through a presentation layer, such as presentation layer 544. In these systems, the application/module “logic” can be separated from the aspects of the application/module that interact with a user.

Some software architectures utilize virtual machines. For example, the various environments described herein may implement one or more virtual machines executing to provide a software application or service. The example of FIG. 5 illustrates by virtual machine 548. A virtual machine creates a software environment where applications/modules can execute as if they were executing on a hardware computing device. A virtual machine 548 is hosted by a host operating system (operating system 514) and typically, although not always, has a virtual machine monitor 546, which manages the operation of the virtual machine 548 as well as the interface with the host operating system (i.e., operating system 514). A software architecture executes within the virtual machine 548. The software architecture may be or include, for example, an operating system 550, libraries 552, frameworks/middleware 554, applications 556 and/or presentation layer 558. These layers of software architecture executing within the virtual machine 548 can be the same as corresponding layers previously described or may be different.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

Computer software, including code for implementing software services, can be written in any form of programming language, including compiled or interpreted languages, and it can be deployed in any form, including as a standalone program or as a module, subroutine, or other unit suitable for use in a computing environment. Computer software can be deployed to be executed on one computer or on multiple computers at one site or distributed across multiple sites and interconnected by a communication network.

In example embodiments, operations may be performed by one or more programmable processors executing a computer program to perform functions by operating on input data and generating output.

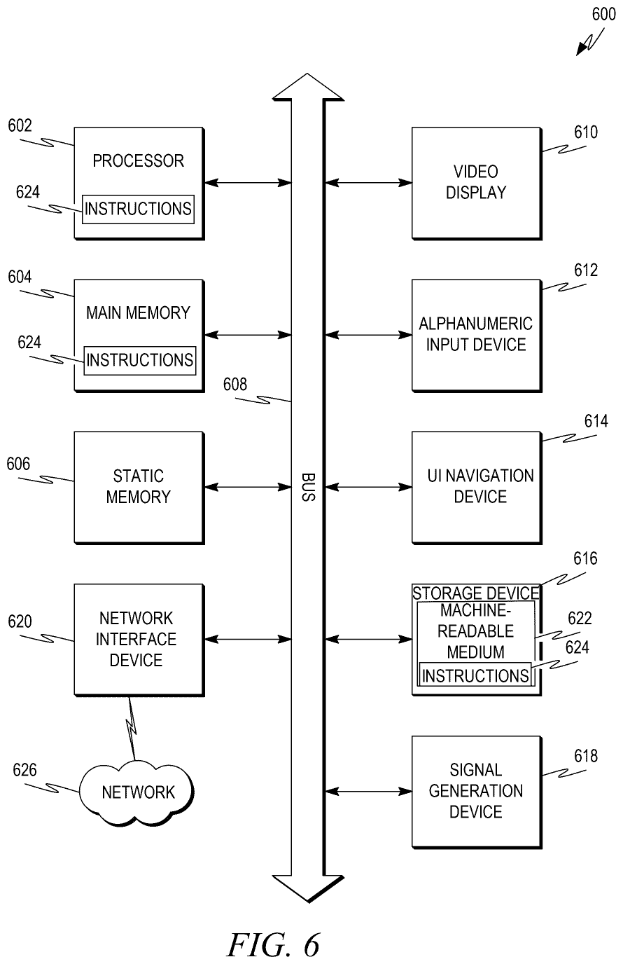

FIG. 6 is a block diagram of a machine in the example form of a computer system 600 within which instructions 624 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604, and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard or a touch-sensitive display screen), a user interface (UI) navigation (or cursor control) device 614 (e.g., a mouse), a storage device 616, such as a disk drive unit, a signal generation device 618 (e.g., a speaker), and a network interface device 620.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media 622.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding, or carrying instructions 624 for execution by the machine and that cause the machine to perform any one or more of the methodologies of the present disclosure, or that is capable of storing, encoding, or carrying data structures utilized by or associated with such instructions 624. The term “machine-readable medium” shall accordingly be taken to include, but not be limited to, solid-state memories, and optical and magnetic media. Specific examples of machine-readable media 622 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi and WiMax networks). The term “transmission medium” shall be taken to include any intangible medium that is capable of storing, encoding, or carrying instructions 624 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for testing a software application, comprising:
at least one processor programmed to perform operations comprising:
accessing first test case execution data, the first test case execution data describing a first plurality of trial test case executions against the software application with a trial timeout threshold;
based at least in part on the first test case execution data, determining a timeout probability for the first plurality of trial test case executions;
selecting a first timeout threshold based at least in part on a test case execution cost associated with the first plurality of trial test case executions and at least in part on the timeout probability for the first plurality of trial test case executions; and
executing at least one test case against the software application using the first timeout threshold.

2. The system of claim 1, the first plurality of trial test case executions comprising executions of a first test case against the software application and executions of a second test case against the software application, the executing of the at least one test case against the software application comprising:
executing the first test case against the software application using the first timeout threshold; and
executing the second test case against the software application using the first timeout threshold.

3. The system of claim 1, the executing of the at least one test case against the software application using the first timeout threshold comprising executing a first test case against the software application using the first timeout threshold, the operations further comprising:
data describing a second plurality of trial test case executions of a second test case against the software application with the trial timeout threshold;
based at least in part on the second test case execution data, determining a timeout probability for the second test case;
selecting a second timeout threshold based at least in part on a test case execution cost associated with the second test case and at least in part on the timeout probability for the second test case; and
executing the second test case against the software application using the second timeout threshold.

4. The system of claim 1, the selecting of the first timeout threshold comprising selecting the first timeout threshold to minimize the test case execution cost associated with the first plurality of trial test case executions.

5. The system of claim 4, the operations further comprising:
determining an expression of the test case execution cost, the expression of the test case execution cost being based at least in part on a mean execution time of the first plurality of trial test case executions, a re-execution time for timed-out test case executions, and the timeout probability for the first plurality of trial test case executions; and
selecting the first timeout threshold to minimize the expression of the test case execution cost with the timeout probability.

6. The system of claim 1, the selecting of the first timeout threshold also being based at least in part on a re-execution time for timed-out test case executions.

7. The system of claim 6, the re-execution time for timed-out test case executions being based at least in part on a number of re-executions performed for timed-out test case executions.

8. The system of claim 1, the selecting of the first timeout threshold also being based at least in part on a manual review time for manually reviewing results of timed-out test cases.

9. The system of claim 1, the first timeout threshold being less than the trial timeout threshold.

10. A method of testing a software application, comprising:
accessing first test case execution data, the first test case execution data describing a first plurality of trial test case executions against the software application with a trial timeout threshold;
based at least in part on the first test case execution data, determining a timeout probability for the first plurality of trial test case executions;
selecting a first timeout threshold based at least in part on a test case execution cost associated with the first plurality of trial test case executions and at least in part on the timeout probability for the first plurality of trial test case executions; and
executing at least one test case against the software application using the first timeout threshold.

11. The method of claim 10, the first plurality of trial test case executions comprising executions of a first test case against the software application and executions of a second test case against the software application, the executing of the at least one test case against the software application comprising:
executing the first test case against the software application using the first timeout threshold; and
executing the second test case against the software application using the first timeout threshold.

12. The method of claim 10, the executing of the at least one test case against the software application using the first timeout threshold comprising executing a first test case against the software application using the first timeout threshold, the method further comprising:
data describing a second plurality of trial test case executions of a second test case against the software application with the trial timeout threshold;
based at least in part on the second test case execution data, determining a timeout probability for the second test case;
selecting a second timeout threshold based at least in part on a test case execution cost associated with the second test case and at least in part on the timeout probability for the second test case; and
executing the second test case against the software application using the second timeout threshold.

13. The method of claim 10, the selecting of the first timeout threshold comprising selecting the first timeout threshold to minimize the test case execution cost associated with the first plurality of trial test case executions.

14. The method of claim 13, further comprising:
determining an expression of the test case execution cost, the expression of the test case execution cost being based at least in part on a mean execution time of the first plurality of trial test case executions, a re-execution time for timed-out test case executions, and the timeout probability for the first plurality of trial test case executions; and
selecting the first timeout threshold to minimize the expression of the test case execution cost with the timeout probability.

15. The method of claim 10, the selecting of the first timeout threshold also being based at least in part on a re-execution time for timed-out test case executions.

16. The method of claim 15, the re-execution time for timed-out test case executions being based at least in part on a number of re-executions performed for timed-out test case executions.

17. The method of claim 10, the selecting of the first timeout threshold also being based at least in part on a manual review time for manually reviewing results of timed-out test cases.

18. The method of claim 10, the first timeout threshold being less than the trial timeout threshold.

19. A non-transitory machine-readable medium comprising instructions thereon that, when executed by at least one processor, because the at least one processor to perform operations comprising:
accessing first test case execution data, the first test case execution data describing a first plurality of trial test case executions against a software application with a trial timeout threshold;
based at least in part on the first test case execution data, determining a timeout probability for the first plurality of trial test case executions;
selecting a first timeout threshold based at least in part on a test case execution cost associated with the first plurality of trial test case executions and at least in part on the timeout probability for the first plurality of trial test case executions; and
executing at least one test case against the software application using the first timeout threshold.

20. The non-transitory machine-readable medium of claim 19, the first plurality of trial test case executions comprising executions of a first test case against the software application and executions of a second test case against the software application, the executing of the at least one test case against the software application comprising:
executing the first test case against the software application using the first timeout threshold; and
executing the second test case against the software application using the first timeout threshold.
